(19) United States
(12) Patent Application Publication
(10) Pub. No.: US 2024/0295907 A1
(43) Pub. Date: Sep. 5, 2024

(54) Protective Case for an Electronic Device with a Touchscreen

(71) Applicant: John Burke, JR., Naperville, IL (US)

(72) Inventor: John Burke, JR., Naperville, IL (US)

(21) Appl. No.: 18/594,144

(22) Filed: Mar. 4, 2024

Related U.S. Application Data
(60) Provisional application No. 63/449,403, filed on Mar. 2, 2023.

(51) Int. Cl. G06F 1/16

(52) U.S. Cl. CPC G06F 1/166; G06F 1/1643; G06F 1/1681

(57) ABSTRACT

A protective case for a touchscreen is provided. The protective case includes a housing having a front panel that removably secures to a rear panel, forming a compartment for receiving an electronic device with a touchscreen. A keyguard is disposed over an opening on the front panel that prohibits a user from getting their fingers stuck in between the keyguard and device. A rotatable stand extends from a rear side of the housing to position the touchscreen in different orientations. A locking mechanism with a latch can secure the touchscreen within the housing and move between an open and closed position. In the open position, the latch is moved away from the housing allowing the front panel to be selectively removed from the rear panel. In the closed position, the latch is received within a recessed portion of the housing, thereby securing the device within the housing.

### BACKGROUND OF THE INVENTION

The present invention relates to electronic device cases. The present invention provides a protective case for a touchscreen having a locking mechanism that secures a touchscreen device within the case, wherein the case includes a keyguard for preventing damage to the touchscreen while allowing access thereto.

In the realm of mobile technology, touchscreen devices such as smartphones, tablets, and various handheld gadgets have become an integral part of our daily lives and indispensable tools for communication, entertainment, education, and professional tasks. These devices, with their sleek designs and sensitive touchscreens, offer unprecedented convenience and functionality to users. However, the delicate nature of these devices makes them susceptible to damage from scratches, drops, or other forms of wear and tear. The very features that make these devices so valuable also render them vulnerable, underscoring the critical need for effective protective solutions.

Existing protective cases for touchscreen devices attempt to address these concerns but often fall short in several key areas. Firstly, many cases offer robust protection at the expense of functionality, limiting users' access to the device's touchscreen and buttons. This can significantly hinder the user experience, making it cumbersome to perform even basic tasks. Conversely, some cases prioritize access over protection, exposing the device to potential damage. For instance, cases that allow full touchscreen access often fails to provide sufficient buffering against impacts or scratches, leaving the device at risk.

Moreover, the integration of stands or handling features in current protective cases is frequently overlooked or inadequately executed. Many cases include stands that are either non-adjustable or offer a limited range of positions, restricting the usability of the device in various settings. Additionally, the lack of ergonomic design in these stands and handles can make extended use of the device uncomfortable, which is particularly problematic for users relying on these devices for prolonged periods, such as for reading, video consumption, or as assistive technology.

Additionally, Assistive Technology (AT) departments in the education system rely on electronic educational devices to assist students to learn. These devices, along with the existing cases used to protect the devices, often become damaged through extensive use and handling by both students and teachers. Furthermore, the cases used by the AT departments tend to cause injuries to the student or instructor and are difficult for the instructor to use.

The protective touchscreen case overcomes these deficiencies by providing a secure and protective solution for touchscreen devices. The case includes a keyguard that provides full access to the touch screen while also protecting the device against accidental damage. The keyguard is designed with smooth walls that will not harm the user, and the case includes a locking mechanism with a latch that secures the device within the housing. The stand is designed to rotate 360 degrees, allowing the user to set the device at the optimal angle for use. Additionally, the design of the case is ergonomic and includes a strap fastener for attaching a shoulder or neck strap for easy carrying. With these features, the protective touchscreen case provides a superior solution for protecting touchscreen devices.

In light of the devices disclosed in the known art, it is submitted that the present invention substantially diverges in design elements and methods from the known art and consequently it is clear that there is a need in the art for an improvement for a protective case. In this regard the instant invention substantially fulfills these needs.

### SUMMARY OF THE INVENTION

In view of the foregoing disadvantages inherent in the known types of protective cases for an electronic device with a touchscreen now present in the known art, the present invention provides a new protective case for an electronic device with a touchscreen wherein the same can be utilized for locking the electronic device within the case and providing a keyguard intended to prevent damage to the touchscreen while allowing access thereto.

It is an objective of the present invention to provide a protective case for a touchscreen comprising a housing with a front panel that can be removed from the rear panel, and a keyguard that covers the touch screen while providing access to the device. The case also includes a locking mechanism with a latch that keeps the device securely in place. The latch can be locked with a key and the case has a strap fastener for attaching a shoulder or neck strap for easy carrying. The front panel can be removed by releasing the latch and pivoting the front panel away from the rear panel.

It is an objective of the present invention to provide a protective case for a touchscreen that provides full access to the device's features. The keyguard is designed to cover the touchscreen while still allowing full access to the device's features, making it an effective solution for protecting the device while still allowing the user to fully utilize its capabilities.

It is another objective of the present invention to provide a secure case for touchscreen devices. The locking mechanism secures the device within the housing, providing a solution that will help to protect the device against accidental damage, making it a durable and long-lasting solution.

It is yet another objective of the present invention to provide an ergonomic and comfortable solution for touch pad devices. The stand is designed to rotate 360 degrees, allowing the user to set the device at the optimal angle for use. Additionally, the design of the case includes a strap fastener for attaching a shoulder or neck strap for easy carrying, making it a comfortable and ergonomic solution for touch pad devices.

It is yet another objective of the present invention to provide a protective case for a touchscreen that supports ease of installation and removal of the touchscreen device. By employing a front panel that can be selectively removed from the rear panel, the case allows for quick and easy access to the device for installation or removal without compromising on protection.

It is therefore an object of the present invention to provide a new and improved protective case for a touchscreen that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the protective case, wherein the protective case is in an open position.

FIG. 2 shows a perspective view of an embodiment of the protective case, wherein the front and rear panel are separated.

FIG. 3 shows a front view of an embodiment of the protective case.

FIG. 4 shows a rear perspective view of an embodiment of the protective case.

FIG. 5 shows another rear perspective view of an embodiment of the protective case.

### DETAILED DESCRIPTION OF THE INVENTION

Reference is made herein to the attached drawings. For the purposes of presenting a brief and clear description of the present invention, the preferred embodiment will be discussed as used for securing a touchscreen device within a protective case and providing a keyguard intended to prevent damage to the touchscreen while allowing access thereto. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

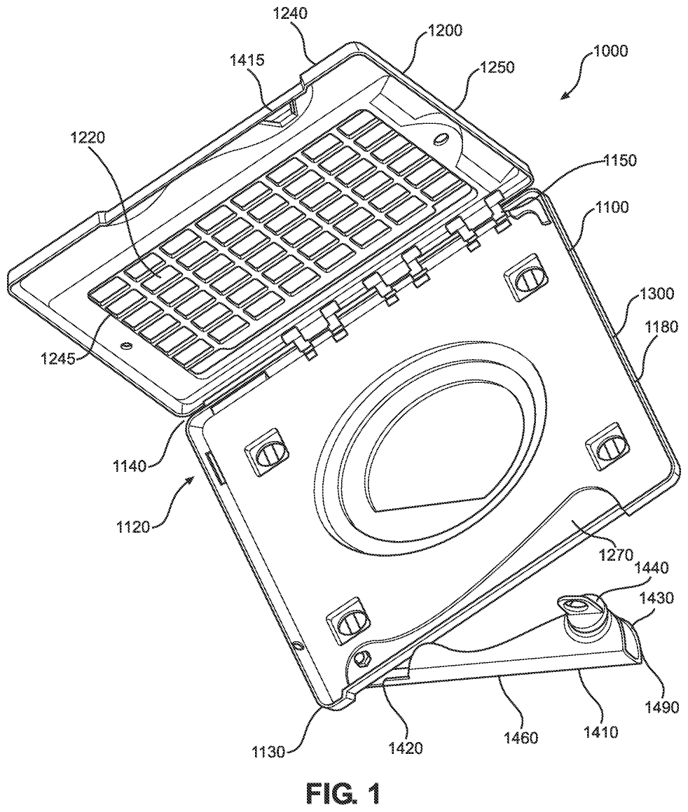

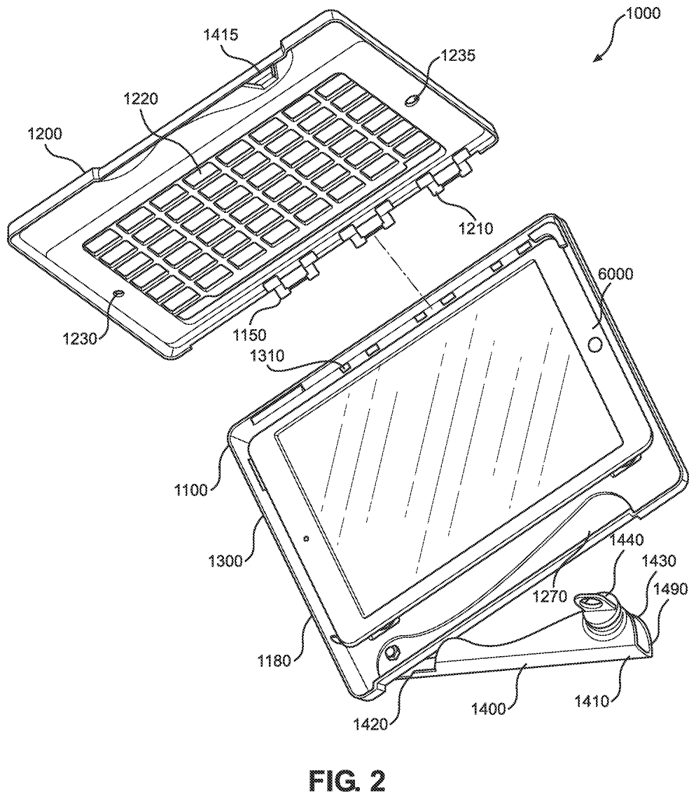

Referring now to FIGS. 1 and 2, there is shown a perspective view of an embodiment of the protective case, wherein the protective case is in an open position and a perspective view of an embodiment of the protective case, wherein the front and rear panel are separated, respectively. The protective case 1000 comprises a housing 1100 having a front panel 1200 secured to a rear panel 1300 forming a compartment 1120 for receiving an electronic device 6000 having a touchscreen, such as a smartphone, tablet, handheld game console, kiosk, menu order terminal, interactive white board, and the like. In the illustrated embodiment, the housing 1100 comprises a cross sectional shape and size configured to conform to the shape and size of the electronic device with the touchscreen intended to be received therein. In this way, the electronic device fits snugly within the housing 1100 and is prevented from moving when disposed within the compartment 1120. In the illustrated embodiment, the length and width of the rear panel 1300 is substantially the same as the length and width of the front panel 1200.

In the illustrated embodiment, the housing 1100 comprises a first side 1130 and an opposing second side 1140, wherein the front panel 1200 is pivotally secured to the rear panel 1300 at the second side 1140 opposite the first side 1130 via a hinge 1150. The hinge 1150 allows for the rotation of the front panel 1200 away from the rear panel 1300. In the illustrated embodiment, the front panel 1200 is removably secured to the rear panel 1300, wherein the rear panel 1300 comprises a plurality of apertures or slots 1310 that are configured to align with and receive a plurality of knuckles 1210 extending from a perimeter of the front panel 1200.

The front panel 1200 comprises an opening 1220 configured to provide access to the touchscreen of the electronic device 6000 when received within the compartment 1120. In the illustrated embodiment, the opening 1220 is adapted to align over the touchscreen of the electronic device 6000. The opening 1220 is defined as the area within the interior sidewalls 1245 of the front panel 1200 (seen covered with a grid-patterned keyguard). In some embodiments, the front panel 1200 comprises one or more apertures on an upper side 1240 thereof or along a sidewall 1250, wherein the aperture is adapted to align with a button, switch, or the like, to allow access thereto while the electronic device 6000 is secured within the housing 1100. In the illustrated embodiment, the upper side 1240 of the front panel 1200 comprises a camera aperture 1230 and a home screen button 1235.

In the shown embodiment, the protective case 1000 further comprises a locking mechanism 1400 configured to secure the front panel 1200 to the rear panel 1300 such that the electronic device 6000 remains within the housing 1100 until the locking mechanism 1400 is released. In the illustrated embodiment, the locking mechanism 1400 comprises a latch 1410 that is pivotally connected to the rear panel 1300 and adapted to transition between an open position and a closed position. The latch 1410 is elongated and comprises a U-shaped cross section the fits around the front and rear panel in a closed configuration. In the illustrated embodiment, a length of the latch comprises a majority of a length of the housing 1100, wherein the length is measured between lateral sides 1180 of the housing 1100.

A first end 1420 of the latch 1410 extends pivotally via hinge (seen in FIG. 5, annotation 1425) from an exterior side of the rear panel 1300. The second end 1430 of the latch 1410 forms the U-shaped member 1490 configured to rest within a pair of recessed areas 1270 disposed on exterior sides of both the front and rear panels 1200, 1300 in the closed position. In the shown embodiment, the second end 1430 of the latch 1410 comprises a lock 1440 that when positioned within a keyhole 1415 within the recessed area 1270 of the front panel 1200 is configured to rotate in a first direction to lock and rotate in a second direction to unlock.

In the open position, the latch 1410 is moved away from the housing 1100 allowing the front panel 1200 to be selectively removed or otherwise separated from the rear panel 1300. When the rear panel 1300 and front panel 1200 are joined together, the latch 1410 is moved from the open position to the closed position to secure the electronic device 6000 within the protective case 1000. In the closed position, the latch 1410 is received within the recessed areas 1270, thereby positioning the front panel 1200 and the rear panel 1300 within the U-shaped member 1490 of the latch 1410.

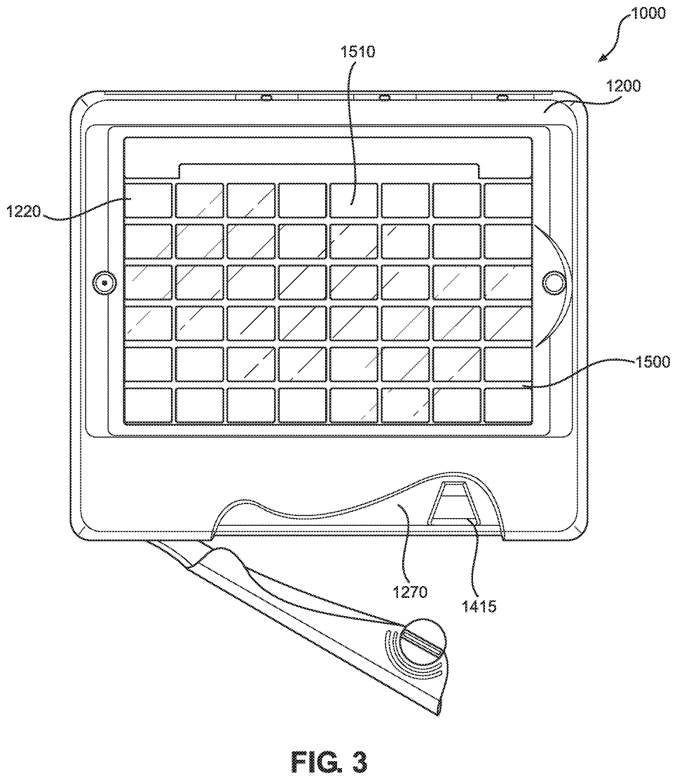

Referring now to FIG. 3, there is shown a front view of an embodiment of the protective case. In the illustrated embodiment, the protective case 1000 comprises a keyguard 1500 disposed over the opening 1220 of the front panel 1200 to protect the touchscreen from damage while still allowing user access to the touchscreen. In the illustrative embodiment, the keyguard 1500 is part of Assistive Technology in the educational system to help students with disabilities use an electronic device with a touchscreen. In the illustrated embodiment, the keyguard 1500 comprises a plurality of windows 1510 disposed in a grid pattern. In other embodiments, the windows 1500 are disposed in any suitable configuration that allows access to the touchscreen while having a portion of the keyguard extend across the touchscreen to provide protection thereto. In the illustrated embodiment, the keyguard 1500 is disposed on a same plane as the opening 1220 of the front panel 1200 to prohibit a user from getting a finger stuck in between the keyguard 1500 and the touchscreen. The keyguard 1500 further comprises rounded or smooth surfaces to prevent a user from cutting or injuring a finger or hand when using the electronic device 6000 through the protective case 1000. In some embodiments, the keyguard 1500 is removably secured to the front panel 1200.

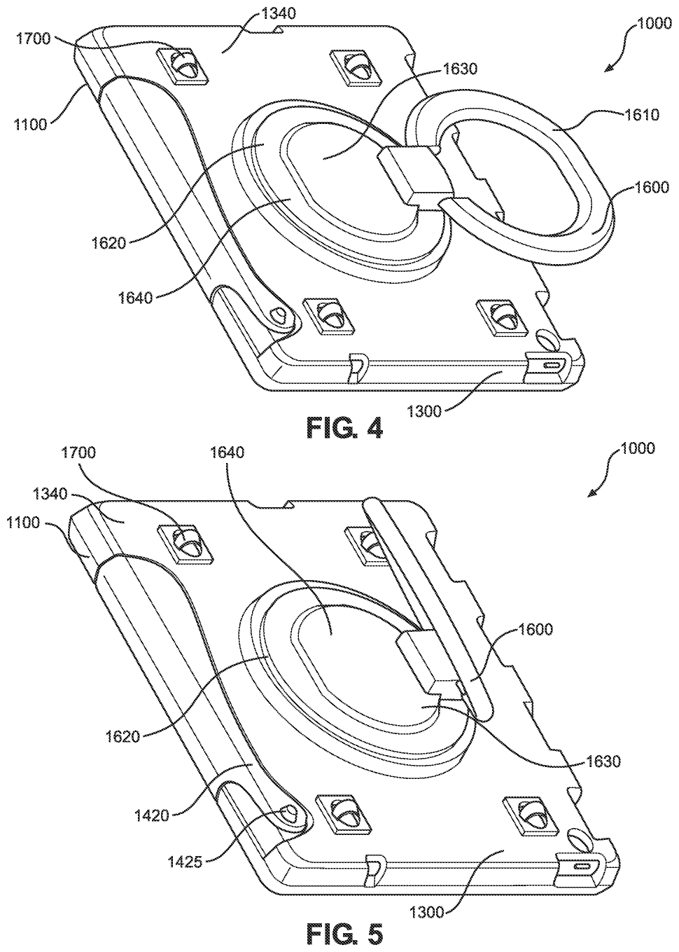

Referring now to FIGS. 4 and 5, there are shown rear perspective views of an embodiment of the protective case. In the illustrated embodiment, a stand 1600 extends from a rear side 1340 of the rear panel 1300, wherein the stand 1600 is adapted to rotate 360 degrees. The rotation of the stand 1600 allows the housing 1100 to be held in a variety of orientations to allow the electronic device to be oriented in an upright position, a horizontal position, or another desired angle. When the stand 1600 is rotated 180 degrees, it forms a handle 1610 that is substantially parallel to the housing 1100. In the illustrated embodiment, the stand 1600 comprises a closed loop, wherein alternate embodiments, the stand 1600 comprises any shape configured to support the housing 1100. In the shown embodiment, the rear side 1340 of the rear panel 1300 further comprises a stand holder 1620 configured to receive the stand 1600 in a stored configuration. The stand holder 1620 comprises a raised platform 1630 the is received through the ring opening of the stand 1600 when in the stored configuration and a shoulder 1640 formed below the platform 1630 for receiving a lower side of the stand 1600 thereon. The stand 1600 is pivotally secured to one side of the rear panel 1300, opposite the locking mechanism.

In some embodiments, the housing 1100 includes a strap fastener 1700 configured to receive a shoulder or neck strap. In the illustrated embodiment, a strap fastener 1700 is disposed at each corner of the rear panel 1300. The strap fastener 1700 comprises an apertured protrusion extending from the rear panel 1300. However, in alternate embodiments, the strap fastener comprises any suitable configuration adapted to secure a strap thereto, such as a clip, hook, slot, and the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A protective case for an electronic device with a touchscreen, comprising:
a housing having a front panel secured to a rear panel forming a compartment;
wherein the front panel comprises an opening configured to access the touchscreen of the electronic device received within the compartment;
a locking mechanism comprising a latch having a first end pivotally connected to the rear panel and adapted to transition between an open position and a closed position;
a first recessed area on the front panel sized to receive a second end of the latch in the closed position, wherein the closed position the latch secures the electronic device within the housing.

2. The protective case of claim 1, further comprising a second recessed area disposed on the rear panel sized to receive the latch in the closed position.

3. The protective case of claim 2, wherein the open position, the latch is positioned away from the housing allowing the front panel to be selectively removed from the rear panel.

4. The protective case of claim 3, wherein the second end of the latch comprises a U-shaped cross section, thereby receiving the front panel and the rear panel between the U-shaped latch in the closed position.

5. The protective case of claim 4, wherein the first and second recessed areas comprise a same perimeter shape.

6. The protective case of claim 4, further comprising a stand extending from the rear panel, wherein the stand is adapted to rotate 360 degrees to support the housing in a plurality of orientations.

7. The protective case of claim 6, wherein the stand, when rotated 180 degrees, forms a handle for carrying the housing.

8. The protective case of claim 7, wherein the stand comprises a ring shape.

9. The protective case of claim 8, further comprising a stand holder configured to receive the stand in a stored configuration, wherein the stand holder comprises a raised platform that is received through an opening of the ring the stored configuration and a shoulder formed below the platform for receiving a lower side of the ring thereon.

10. The protective case of claim 1, further comprising a keyguard disposed over the opening of the front panel, wherein the keyguard comprises a plurality of windows for accessing the touchscreen therethrough.

11. The protective case of claim 10, wherein the plurality of windows are arranged in a grid pattern.

12. The protective case of claim 1, further comprising a key to lock and unlock the locking mechanism.

13. The protective case of claim 1, wherein the front panel is removably secured to the rear panel at a second side opposite a first side via a hinge.

14. The protective case of claim 13, wherein the hinge allows for the separation and rotation of the front panel away from the rear panel when the latch is in an open position.

15. The protective case of claim 1, wherein the housing includes a strap fastener having an apertured protrusion extending from the rear panel and configured to receive a shoulder or neck strap.

16. The protective case of claim 15, wherein a strap fastener is disposed on each corner of the rear panel.

17. The protective case of claim 1, wherein the housing is constructed from a material providing shock absorption and resistance to impact.
